(19) United States
(12) Patent Application Publication
(10) Pub. No.: US 2023/0186930 A1
(43) Pub. Date: Jun. 15, 2023

(54) SPEECH ENHANCEMENT METHOD AND APPARATUS, AND STORAGE MEDIUM

(71) Applicant: Beijing Baidu Netcom Science Technology Co., Ltd., Beijing (CN)

(72) Inventors: Guangzheng LI, Beijing (CN); Guochang ZHANG, Beijing (CN); Libiao YU, Beijing (CN); Jianqiang WEI, Beijing (CN)

(21) Appl. No.: 17/890,638

(22) Filed: Aug. 18, 2022

(30) Foreign Application Priority Data
Dec. 13, 2021 (CN) 202111521637.1

(51) Int. Cl. G10L 21/0208; G10L 25/30

(52) U.S. Cl. CPC G10L 21/0208; G10L 25/30

(57) ABSTRACT

A speech enhancement method includes steps as follows. Subband decomposition processing is performed on at least two paths of target speech to obtain amplitude spectrums and phase spectrums of the at least two paths of target speech, where the at least two paths of target speech include: target mixed speech and target interference speech; a prediction probability of the target mixed speech including target clean speech in a feature domain is determined according to the amplitude spectrums of the at least two paths of target speech; and subband synthesis processing is performed according to the prediction probability and the amplitude spectrums and the phase spectrums of the at least two paths of target speech to obtain the target clean speech in the target mixed speech.

### CROSS-REFERENCE TO RELATED APPLICATION

This application claims priority to Chinese Patent Application No. CN202111521637.1, filed on Dec. 13, 2021, the disclosure of which is incorporated herein by reference in its entirety.

### TECHNICAL FIELD

The present disclosure relates to the technical field of artificial intelligence, in particular, to the deep learning technical field and the speech technical field, and may be applied to an audio communication scene.

### BACKGROUND

Speech enhancement (SE) is a classical technology in the audio communication field and mainly refers to an anti-interference technology for extracting clean speech from a noise background when the clean speech is interfered by noises and/or echoes in the real environment.

The related speech enhancement technology has insufficient capability to suppress noises and/or echoes in mixed speech. As a result, high-quality clean speech cannot be extracted from the mixed speech, which urgently needs to be improved.

### SUMMARY

The present disclosure provides a speech enhancement method and apparatus, a device and a storage medium.

According to an aspect of the present disclosure, a speech enhancement method is provided and includes steps described below.

Subband decomposition processing is performed on at least two paths of target speech to obtain amplitude spectrums and phase spectrums of the at least two paths of target speech, where the at least two paths of target speech include: target mixed speech and target interference speech.

A prediction probability of the target mixed speech including target clean speech in a feature domain is determined according to the amplitude spectrums of the at least two paths of target speech.

Subband synthesis processing is performed according to the prediction probability and the amplitude spectrums and the phase spectrums of the at least two paths of target speech to obtain the target clean speech in the target mixed speech.

According to another aspect of the present disclosure, an electronic device is provided. The electronic device includes at least one processor and a memory communicatively connected to the at least one processor.

The memory stores instructions executable by the at least one processor to cause the at least one processor to execute the speech enhancement method according to any embodiment of the present disclosure.

According to another aspect of the present disclosure, a non-transitory computer-readable storage medium is provided. The storage medium stores computer instructions for causing a computer to execute the speech enhancement method according to any embodiment of the present disclosure.

According to the technology of the present disclosure, the effect of speech enhancement is improved, and a new solution for speech enhancement is provided.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a flowchart of a speech enhancement method according to an embodiment of the present disclosure;

FIG. 2 is a flowchart of a speech enhancement method according to an embodiment of the present disclosure;

FIG. 3 is a structural diagram of a speech enhancement model according to an embodiment of the present disclosure;

FIG. 4 is a flowchart of a speech enhancement method according to an embodiment of the present disclosure;

FIG. 5A is a flowchart of a speech enhancement method according to an embodiment of the present disclosure;

FIG. 5B is a diagram showing the principle of a speech enhancement method according to an embodiment of the present disclosure;

FIG. 6A is a flowchart of a speech enhancement method according to an embodiment of the present disclosure;

FIG. 6B is a diagram showing the principle of another speech enhancement method according to an embodiment of the present disclosure;

FIG. 6C is a waveform diagram of target mixed speech containing knocks;

FIG. 6D is a waveform diagram of target clean speech obtained after speech enhancement is performed on target mixed speech containing knocks;

FIG. 6E is a waveform diagram of target mixed speech containing echoes;

FIG. 6F is a waveform diagram of target clean speech obtained after speech enhancement is performed on target mixed speech containing echoes;

FIG. 7 is a structural diagram of a speech enhancement apparatus according to an embodiment of the present disclosure; and

FIG. 8 is a block diagram of an electronic device for implementing a speech enhancement method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

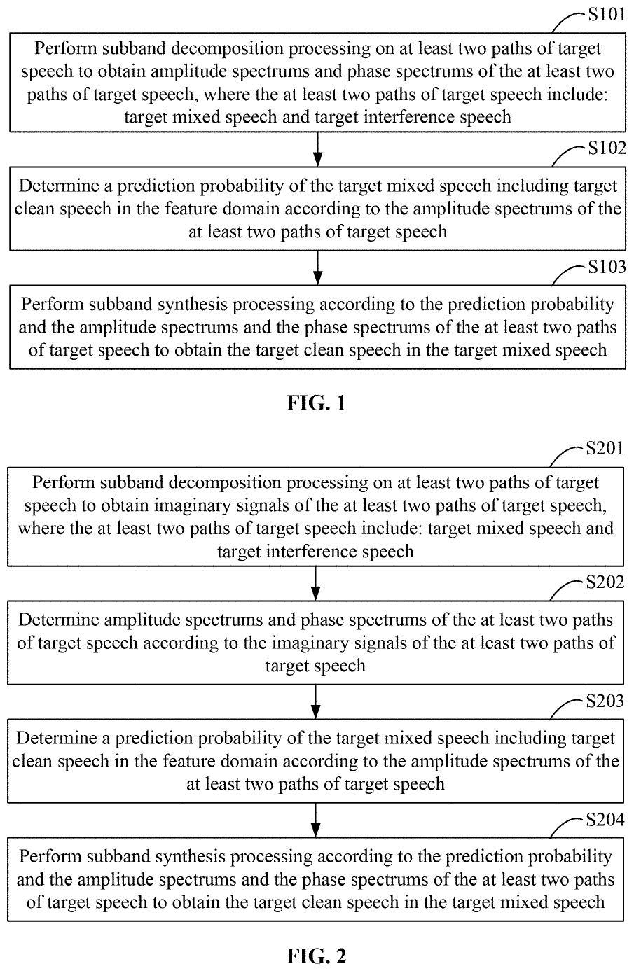

FIG. 1 is a flowchart of a speech enhancement method according to an embodiment of the present disclosure. The embodiment of the present disclosure is applicable to the case of performing speech enhancement on speech mixed with noises and/or echoes. The method may be executed by a speech enhancement apparatus. The apparatus may be implemented by means of software and/or hardware. As shown in FIG. 1, the speech enhancement method provided in the embodiment may include steps described below.

In S101, subband decomposition processing is performed on at least two paths of target speech to obtain amplitude spectrums and phase spectrums of the at least two paths of target speech, where the at least two paths of target speech include: target mixed speech and target interference speech.

The target speech may be the input speech for performing the speech enhancement method. The target speech may include at least two paths of target speech, for example, include at least target mixed speech and target interference speech. The so-called target mixed speech may be clean speech mixed with noises and/or echoes. The target mixed speech is the speech that needs to be subjected to speech enhancement processing (that is, noises and/or echoes in the target mixed speech needs to be removed).

Exemplarily, the speech signal of the target mixed speech is as follows:

y(t)=s(t)+n(t)+e(t).

y(t) represents the target mixed speech, s(t) represents the clean speech, n(t) represents noises, and e(t) represents echoes.

Optionally, in the case of performing speech enhancement on an audio communication device deployed with multiple directional microphones, since the multiple directional microphones all perform speech collection, in the embodiment, energy intensity analysis may be performed on the speech collected by the various paths of directional microphones, and the speech collected by the path of directional microphone having the strongest energy is used as the target mixed speech that needs to be subjected to speech enhancement.

The target interference speech may refer to a signal associated with noises and/or echoes mixed in the target mixed speech. For example, the target interference speech may be far-end speech resulting in echoes, and/or a standard noise signal associated with a noise source, etc. For example, in a speech communication scene with knocks, the target mixed speech collected by a microphone of a speech communication device includes: input speech of a local user (that is, the clean speech), the knocks in the environment (that is, noises), and echoes in the environment of output speech of a far-end user who is talking with the local user. Correspondingly, the target interference speech at this time may be standard noise set for the thing emitting the knocks in the scene, and/or the output speech of the far-end user.

It is to be noted that the purpose of this example is to filter out the noises and/or echoes contained in the target mixed speech from the target mixed speech to obtain interference-free clean speech, that is, to restore the clean speech s(t) from the preceding speech signal y(t) as much as possible through the speech enhancement processing.

Optionally, the target speech signal in the embodiment is a time domain signal. The time domain signal represents a dynamic signal with the time axis as a coordinate. To reduce the calculation burden of the signal enhancement process, in the embodiment, each path of target speech may be separately processed based on the subband decomposition technology so that each path of target speech is converted from a time domain signal into a feature domain signal (such as a frequency domain signal), that is, an imaginary signal in a feature domain, and then amplitude values and phase values of the feature domain signal at different points in the feature domain are calculated so as to obtain an amplitude spectrum and a phase spectrum of the feature domain signal in the feature domain. That is, an amplitude spectrum and a phase spectrum of each path of target speech are obtained.

For example, in the embodiment, each path of target speech may be processed sequentially by calling a subband decomposition algorithm, so as to obtain the amplitude spectrum and the phase spectrum of the each path of target speech. Moreover, each path of target speech may also be processed sequentially through a pre-trained subband decomposition model or in other manners, which is not limited here.

In S102, a prediction probability of the target mixed speech including target clean speech in the feature domain is determined according to the amplitude spectrums of the at least two paths of target speech.

The target clean speech may be the speech obtained by removing noises and/or echoes mixed in the target mixed speech. For example, in a speech communication scene with knocks, input speech of a local user collected by a microphone of a speech communication device is the target clean speech. The so-called prediction probability of the target mixed speech including the target clean speech in the feature domain refers to a prediction probability of the target mixed speech including the target clean speech at each point in the feature domain. For example, if the feature domain is the frequency domain, each point in the feature domain is each frequency point in the frequency domain.

In an optional implementation of the embodiment, feature analysis may be performed on an amplitude spectrum of the target mixed speech and an amplitude spectrum of the target interference speech separately based on a preset speech signal processing algorithm, and in combination with the correlation between the amplitude spectrum feature of the target interference speech and the amplitude spectrum feature of the target mixed speech at each point in the feature domain, the probability (that is, the prediction probability) of the target mixed speech including the target clean speech at each point in the feature domain is analyzed. For example, if the correlation between the amplitude spectrum feature of the target interference speech and the amplitude spectrum feature of the target mixed speech at a certain point is relatively large, it indicates that the prediction probability of the target clean speech existing at this point is relatively small; if the correlation between the amplitude spectrum feature of the target interference speech and the amplitude spectrum feature of the target mixed speech at a certain point is relatively small, it indicates that the prediction probability of the target clean speech at this point is relatively large.

In another implementation of the embodiment, a neural network model capable of executing a probability prediction task of the target mixed speech including the target clean speech in the feature domain may be pre-trained, in this case, the amplitude spectrums of the at least two paths of target speech may be input into the neural network model, and the network model may predict the probability of the target mixed speech including the target clean speech at each point in the feature domain based on the input amplitude spectrums of various paths of target speech, and output the prediction probability.

It is to be noted that in the embodiment, the prediction probability of the target mixed speech including the target clean speech in the feature domain may also be determined according to the amplitude spectrums of the at least two paths of target speech in other manners, which is not limited.

In S103, subband synthesis processing is performed according to the prediction probability and the amplitude spectrums and the phase spectrums of the at least two paths of target speech to obtain the target clean speech in the target mixed speech.

The subband synthesis processing may be an inverse processing process of the subband decomposition processing, that is, a process of synthesizing a corresponding feature domain signal according to an amplitude spectrum and a phase spectrum of a speech signal and converting a synthesized feature domain signal from the feature domain to the time domain to obtain a time domain speech signal.

Optionally, since noises and echoes in the mixed speech have little interference on the phase value of the clean speech at each point in the feature domain and mainly affect the amplitude value of the clean speech at each point in the feature domain, in the embodiment, the amplitude spectrum of the target mixed speech of the at least two paths of target speech may be adjusted based on the prediction probability of the target mixed speech including the target clean speech at each point in the feature domain, that is, the amplitude value part corresponding to the noises and/or the echoes is removed from the amplitude value of the target mixed speech at each point in the feature domain to obtain an amplitude spectrum of the target clean speech, and then the target clean speech in the target mixed speech is restored by combing the amplitude spectrum of the target clean speech with a phase spectrum of the target mixed speech and calling the subband synthesis algorithm.

Optionally, the process in the embodiment of obtaining the target clean speech through the subband synthesis based on the prediction probability and the amplitude spectrum and the phase spectrum of the target mixed speech of the at least two paths of target speech may also be implemented through a pre-trained subband synthesis model or in other manners, which is not limited.

According to the technical solution of the embodiment of the present disclosure, the subband decomposition is performed on the target mixed speech and the target interference speech associated with the target mixed speech separately to determine the amplitude spectrums and the phase spectrums of the two paths of speech, the prediction probability of the target mixed speech including the target clean speech at each point in the feature domain is predicted based on the amplitude spectrums of the two paths of speech, and the target clean speech is extracted from the target mixed speech by combining the amplitude spectrum of the target mixed speech with the phase spectrum of the target mixed speech and through the subband synthesis processing. According to the solution, the subband decomposition and subband synthesis technologies are used for replacing the related Fourier transform to execute the operations of speech frequency spectrum decomposition and speech frequency spectrum synthesis, and a longer analysis window is used, so that the correlation between various subbands is less, the subsequent task of noise filtering and/or echo filtering has a higher convergence efficiency, the noises and/or echoes in the target mixed speech can be cancelled to the maximum extent, and thus high-quality target clean speech can be obtained. In addition, in the speech enhancement process of the embodiment, the target interference speech associated with the noises and/or echoes in the target mixed speech is used, so that the quality of the target clean speech is further improved.

Optionally, in the embodiment, after the amplitude spectrum of each path of target speech is obtained through the subband decomposition technology, the amplitude spectrums of the at least two paths of target speech may further be updated based on logarithm processing and/or normalization processing. For example, logarithm processing (that is, log processing) and/or normalization processing may be performed on the amplitude spectrum of each path of target speech obtained through the subband decomposition technology to compress the dynamic range of the amplitude spectrum, so that the convergence efficiency of the subsequent task of noise filtering and/or echo filtering is improved.

FIG. 2 is a flowchart of a speech enhancement method according to an embodiment of the present disclosure. Based on the preceding embodiment, the embodiment of the present disclosure further explains how to perform the subband decomposition processing on the at least two paths of target speech to obtain the amplitude spectrums and the phase spectrums of the at least two paths of target speech. As shown in FIG. 2, the speech enhancement method provided in the embodiment may include steps described below.

In S201, subband decomposition processing is performed on at least two paths of target speech to obtain imaginary signals of the at least two paths of target speech, where the at least two paths of target speech include: target mixed speech and target interference speech.

An imaginary signal is a speech signal characterized in an imaginary manner in a feature domain (for example, a frequency domain). The imaginary signal may include a real part and an imaginary part.

Optionally, the embodiment is based on the subband decomposition technology, for the process of processing each path of target speech, a low-pass filter may be designed first, and complex modulation is performed to obtain various subband filters; then for each path of target speech, convolution filtering is performed on the speech signal of the each path of target speech separately with each subband filter to obtain each subband signal of the each path of modulated target speech; then, each subband signal is decimated (that is, downsampled) to generate an imaginary signal of the each path of target speech signal.

In S202, amplitude spectrums and phase spectrums of the at least two paths of target speech are determined according to the imaginary signals of the at least two paths of target speech.

It is to be noted that, with regard to a speech signal, the variation of the amplitude value (|Fn| or Cn) at each point in the feature domain with the angular frequency (ω) is taken as an amplitude spectrum of the speech signal; the variation of the phase value (φ) at each point in the feature domain with the angular frequency (ω) is taken as a phase spectrum of the speech signal. The amplitude spectrum and the phase spectrum of the speech signal are collectively referred to as a frequency spectrum. Optionally, in the embodiment, an imaginary signal of each path of target speech signal may be calculated based on a Fourier transform to obtain the amplitude value (|Fn| or Cn) and the phase value (φ) of the imaginary signal at each point in the feature domain, and thus the amplitude spectrum and the phase spectrum of each path of target speech are obtained.

In S203, a prediction probability of the target mixed speech including target clean speech in the feature domain is determined according to the amplitude spectrums of the at least two paths of target speech.

In S204, subband synthesis processing is performed according to the prediction probability and the amplitude spectrums and the phase spectrums of the at least two paths of target speech to obtain the target clean speech in the target mixed speech.

According to the technical solution of the embodiment of the present disclosure, the subband decomposition is performed on the target mixed speech and the target interference speech associated with the target mixed speech separately to obtain the imaginary signals of the two paths of speech, the amplitude spectrums and the phase spectrums of the two paths of speech are extracted based on the imaginary signals, the prediction probability of the target mixed speech including the target clean speech at each point in the feature domain is predicted based on the amplitude spectrums of the two paths of speech, and the target clean speech is extracted from the target mixed speech by combining the prediction probability with an amplitude spectrum and a phase spectrum of the target mixed speech and through the subband synthesis processing. The solution presents a specific implementation manner for determining the amplitude spectrum and the phase spectrum of the target speech based on the subband decomposition technology, providing technical support for subsequent speech enhancement processing based on the amplitude spectrum and the phase spectrum.

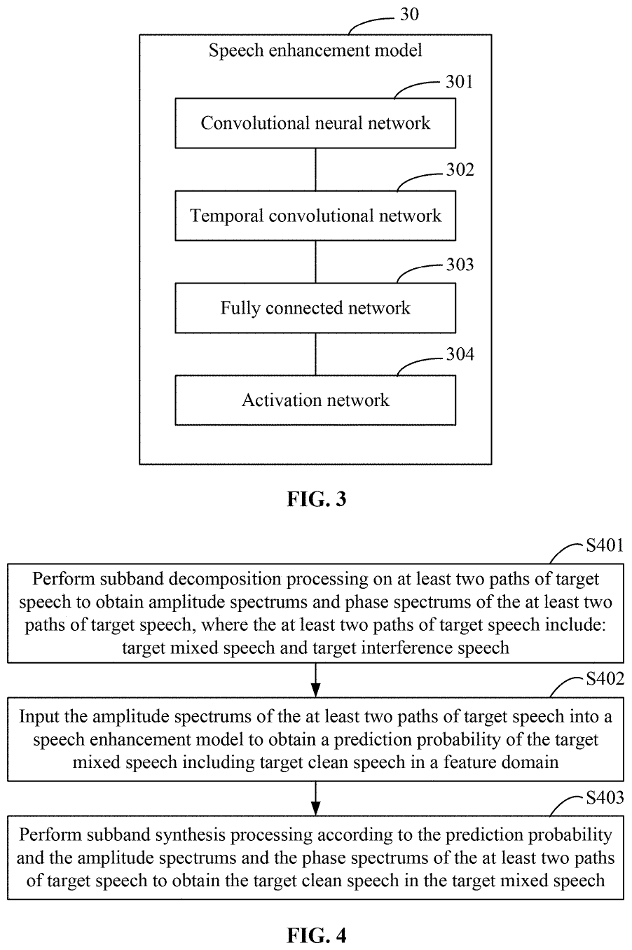

FIG. 3 is a structural diagram of a speech enhancement model according to an embodiment of the present disclosure. As shown in FIG. 3, the speech enhancement model 30 includes: a convolutional neural network (CNN) 301, a temporal convolutional network (TCN) 302, a fully connected (FC) network 303 and an activation network (such as Sigmoid) 304.

The speech enhancement model 30 is a neural network model for performing a speech enhancement task, and may be, for example, a noise suppression-nonlinear processing (ns-nlp) model. For example, the convolutional neural network (CNN) 301 and the temporal convolutional network (TCN) 302 are mainly used for extracting correlation features between an amplitude spectrum of clean speech and an amplitude spectrum of noises and echoes. The convolutional neural network 301 is used for extracting preliminary correlation features, and the temporal convolutional network 302 is used for further abstracting final correlation features from the preliminary correlation features in combination with temporal features. The fully connected (FC) network 303 and the activation network (such as Sigmoid) 304 are mainly used for predicting a prediction probability of target mixed speech including target clean speech at each point in a feature domain based on the correlation features between the amplitude spectrum of the clean speech and the amplitude spectrum of the noises and echoes. The fully connected network 303 is used for obtaining a preliminary prediction probability, and the activation network 304 is used for performing normalization processing on the preliminary prediction probability to obtain a final prediction probability.

Optionally, the speech enhancement model 30 in the embodiment is obtained through supervised training based on a training sample, where the training sample includes: sample clean speech generated based on directivity of the microphone, sample interference speech, and sample mixed speech obtained by mixing different types of noises and/or echoes into the sample clean speech.

For example, speech from different directions may be fitted based on the directivity of a directional microphone as the sample clean speech. Different types of sample interference speech are fitted. It is to be noted that since echoes are typically generated due to human voice reflections, in the embodiment, the sample interference speech associated with the echoes may be real human speech collected by different communication devices. After the sample clean speech and the sample interference speech are obtained, the sample mixed speech can be obtained by mixing different types of noises and/or echoes into various pieces of sample clean speech based on different types of sample interference speech. In a model training stage, amplitude spectrums of the sample mixed speech, the sample interference speech and the sample clean speech in the training sample may be obtained first based on the subband decomposition technology, and then amplitude spectrums of the sample mixed speech and the sample interference speech in the training sample are taken as the input of the speech enhancement model 30, and the amplitude spectrum of the corresponding sample clean speech is taken as supervision data of the model, so as to perform supervised training on the speech enhancement model 30. In the embodiment, during the process of training the speech enhancement model 30, the sample mixed speech including different types of noises and/or echoes is introduced, so that the trained speech enhancement model 30 has the effect of filtering out noises and echoes, that is, two types of interference speech, at the same time; in the process of fitting the sample clean speech, the microphone selection technology, that is, the directivity of the directional microphone, is considered, so that the trained speech enhancement model 30 can work better on the speech communication device having multiple paths of directional microphones; therefore, the noise residual and/or echo residual in the communication process are effectively reduced, the problem of speech suppression caused by the conventional manner for speech enhancement based on filters is alleviated. In addition, the accuracy of the speech enhancement model 30 is improved through the supervised training.

FIG. 4 is a flowchart of a speech enhancement method according to an embodiment of the present disclosure. Based on the preceding embodiments, the embodiment of the present disclosure further explains how to determine the prediction probability of the target mixed speech including the target clean speech in the feature domain according to the amplitude spectrums of the at least two paths of target speech. As shown in FIG. 3 and FIG. 4, the speech enhancement method provided in the embodiment may include steps described below.

In S401, subband decomposition processing is performed on at least two paths of target speech to obtain amplitude spectrums and phase spectrums of the at least two paths of target speech, where the at least two paths of target speech include: target mixed speech and target interference speech.

In S402, the amplitude spectrums of the at least two paths of target speech are input into a speech enhancement model to obtain a prediction probability of the target mixed speech including target clean speech in a feature domain.

For example, in the embodiment, amplitude spectrums of various paths of target speech may be simultaneously input into the convolutional neural network 301 in the speech enhancement model 30 shown in FIG. 3. The convolutional neural network 301 may perform correlation analysis on the input amplitude spectrums of the various paths of target speech signals to obtain the preliminary correlation features between the amplitude spectrum of the clean speech and the amplitude spectrum of the noises and echoes, and input the preliminary correlation features into the temporal convolutional network 302. The temporal convolutional network 302 may further abstract the final correlation features between the amplitude spectrum of the clean speech and the amplitude spectrum of the noises and echoes from the preliminary correlation features in combination with the temporal features, and input the final correlation features into the fully connected network 303. The fully connected network 303 may preliminarily predict a preliminary probability value of the target mixed speech including the target clean speech at each point in the feature domain based on the final correlation features, and input the preliminary probability value into the activation network 304. The activation network 304 may perform normalization processing on the preliminary probability value, that is, normalizes the probability of the target mixed speech including the target clean speech at each point in the feature domain to the range of 0 to 1, and then the prediction probability finally output by the speech enhancement model 30 is obtained.

In S403, subband synthesis processing is performed according to the prediction probability and the amplitude spectrums and the phase spectrums of the at least two paths of target speech to obtain the target clean speech in the target mixed speech.

According to the technical solution of the embodiment of the present disclosure, the subband decomposition is performed on the target mixed speech and the target interference speech associated with the target mixed speech separately to determine the amplitude spectrums and the phase spectrums of the two paths of speech, the prediction probability of the target mixed speech including the target clean speech at each point in the feature domain is predicted based on the analysis performed by the speech enhancement model including the convolutional neural network, the temporal convolutional network, the fully connected network and the activation network on the amplitude spectrums of the two paths of speech, and the target clean speech is extracted from the target mixed speech by combining the prediction probability with an amplitude spectrum and a phase spectrum of the target mixed speech and through the subband synthesis processing. In the solution, the speech enhancement model is introduced to replace conventional signal filters for noise suppression and/or echo suppression, so that system modules are effectively simplified, and other potential problems caused by bipolar processing are avoided. In addition, the speech enhancement model in the solution abstracts the correlation features between the amplitude spectrum of the clean speech and the amplitude spectrum of the noises and echoes based on the temporal convolutional network, and thus extracts more accurate correlation features and requires less calculation amount and less model parameters compared with based on conventional feature extraction networks such as a long short-term memory (LSTM) network and a gated recurrent unit (GRU). In this manner, the accuracy of the prediction probability output by the speech enhancement model is ensured, and the calculation amount and the number of parameters of the speech enhancement model are reduced.

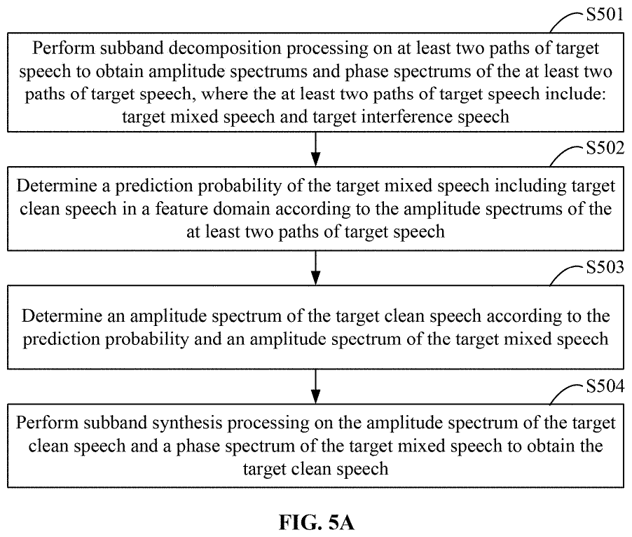

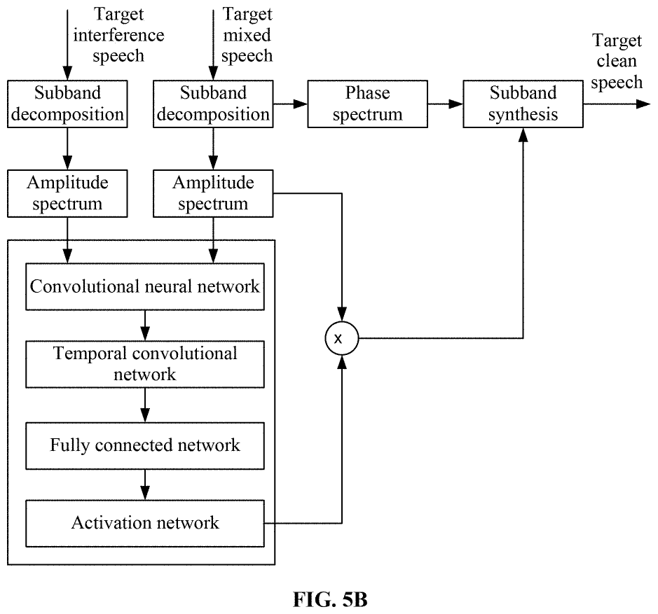

FIG. 5A is a flowchart of a speech enhancement method according to an embodiment of the present disclosure, and FIG. 5B is a diagram showing the principle of a speech enhancement method according to an embodiment of the present disclosure. Based on the preceding embodiment, the embodiment of the present disclosure further explains how to perform the subband synthesis processing according to the prediction probability and the amplitude spectrums and the phase spectrums of the at least two paths of target speech to obtain the target clean speech in the target mixed speech. As shown in FIG. 5A to FIG. 5B, the speech enhancement method provided in the embodiment may include steps described below.

In S501, subband decomposition processing is performed on at least two paths of target speech to obtain amplitude spectrums and phase spectrums of the at least two paths of target speech, where the at least two paths of target speech include: target mixed speech and target interference speech.

In S502, a prediction probability of the target mixed speech including target clean speech in a feature domain is determined according to the amplitude spectrums of the at least two paths of target speech.

Exemplarily, as shown in FIG. 5B, in the embodiment, the amplitude spectrums of the at least two paths of target speech may be input into a speech enhancement model including a convolutional neural network, a temporal convolutional network, a fully connected network and an activation network, so as to obtain the prediction probability of the target mixed speech including the target clean speech in the feature domain.

In S503, an amplitude spectrum of the target clean speech is determined according to the prediction probability and an amplitude spectrum of the target mixed speech.

Exemplarily, as shown in FIG. 5B, in the embodiment, the prediction probability output by the speech enhancement model may be taken as the weight of the amplitude spectrum of the target mixed speech in the target speech, so as to calculate the amplitude spectrum of the target clean speech. For example, the prediction probability may be multiplied by the amplitude spectrum of the target mixed speech in the target speech to obtain the amplitude spectrum of the target clean speech.

In S504, subband synthesis processing is performed on the amplitude spectrum of the target clean speech and a phase spectrum of the target mixed speech to obtain the target clean speech.

Exemplarily, as shown in FIG. 5B, in the embodiment, speech synthesis processing may be performed on the amplitude spectrum of the target clean speech and the phase spectrum of the target mixed speech based on the subband synthesis technology to obtain the target clean speech.

According to the technical solution of the embodiment of the present disclosure, the subband decomposition is performed on the target mixed speech and the target interference speech associated with the target mixed speech separately to determine the amplitude spectrums and the phase spectrums of the two paths of speech, the prediction probability of the target mixed speech including the target clean speech at each point in the feature domain is predicted based on the amplitude spectrums of the two paths of speech, the amplitude spectrum of the target clean speech is calculated according to the prediction probability and the amplitude spectrum of the target mixed speech, and the target clean speech is obtained by combining the amplitude spectrum of the target clean speech with the phase spectrum of the target mixed speech and through the subband synthesis technology. The solution provides a specific implementation manner for determining the target clean speech according to the prediction probability and the amplitude spectrum and the phase spectrum of the target mixed speech based on the subband synthesis technology, which provides technical support for the speech enhancement processing in the embodiment.

Optionally, in the embodiment of the present disclosure, based on the preceding embodiments, preprocessed speech obtained after initial echo cancellation and/or noise cancellation are performed on the target mixed speech may further be added to the at least two paths of target speech.

The manner for performing initial echo cancellation and/or noise cancellation on the target mixed speech may include the following: stationary noise removal is performed on the target mixed speech by using a Wiener filter based on the noise suppression (NS) technology; and/or, linear echo cancellation is performed on the target mixed speech based on the linear Acoustic Echo Cancellation (AEC) technology, for example, based on a normalized least mean squares (NLMS) filter of the adaptive theory.

It is to be noted that for the preprocessed speech obtained based on the noise cancellation technology, only stationary noises in the target mixed speech are removed, but non-stationary short-term noises (for example, knocks) still remain; for the preprocessed speech obtained based on the linear Acoustic Echo Cancellation technology, only linear echoes in the target mixed speech are removed, but nonlinear echoes still remain.

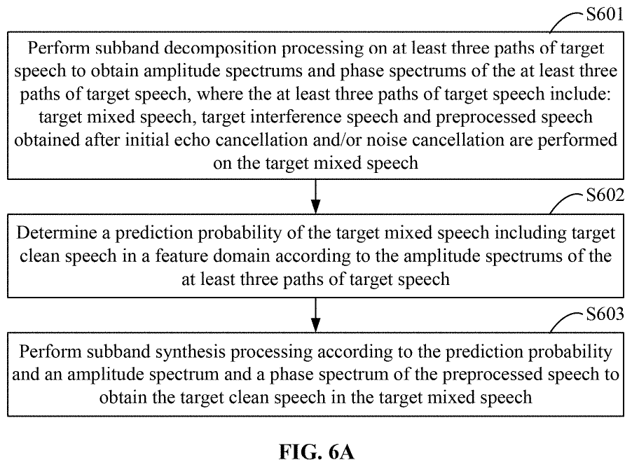

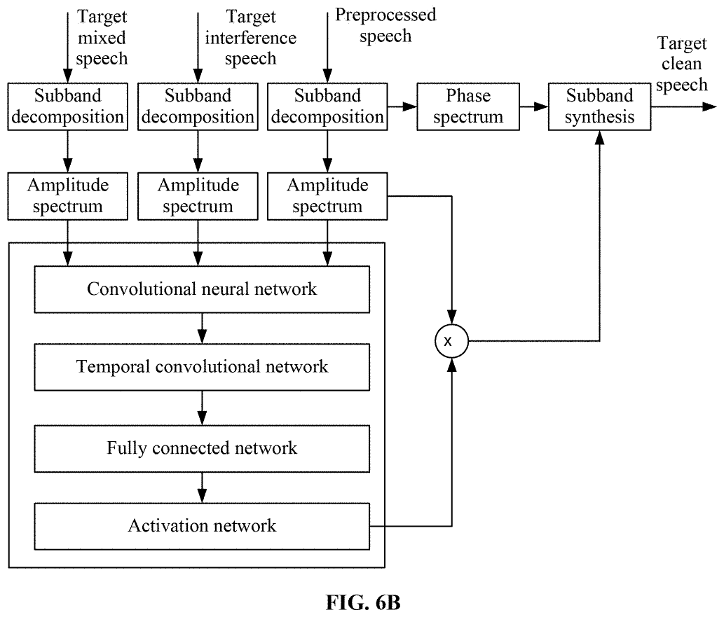

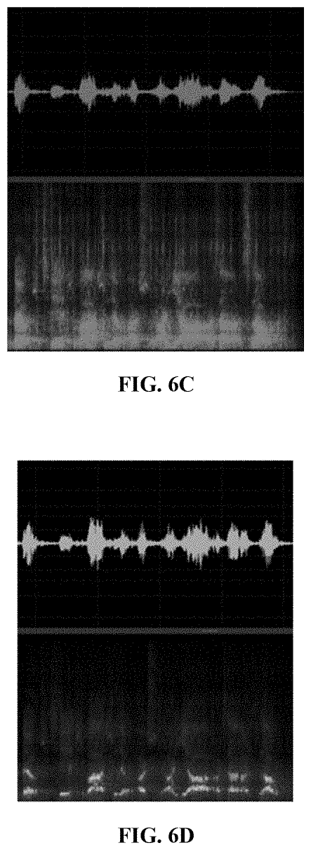

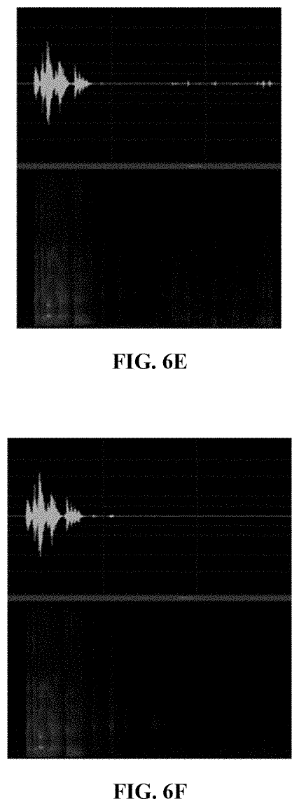

FIG. 6A is a flowchart of a speech enhancement method according to an embodiment of the present disclosure; FIG. 6B is a diagram showing the principle of another speech enhancement method according to an embodiment of the present disclosure; FIG. 6C is a waveform diagram of target mixed speech containing knocks; FIG. 6D is a waveform diagram of target clean speech obtained after speech enhancement is performed on target mixed speech containing knocks; FIG. 6E is a waveform diagram of target mixed speech containing echoes; FIG. 6F is a waveform diagram of target clean speech obtained after speech enhancement is performed on target mixed speech containing echoes. In the case where the at least two paths of target speech include target mixed speech, target interference speech and preprocessed speech, the embodiment further explains how to perform the subband synthesis processing according to the prediction probability and the amplitude spectrums and the phase spectrums of the at least two paths of target speech to obtain the target clean speech in the target mixed speech. As shown in FIGS. 6A to 6F, the speech enhancement method provided in the embodiment may include steps described below.

In S601, subband decomposition processing is performed on at least three paths of target speech to obtain amplitude spectrums and phase spectrums of the at least three paths of target speech, where the at least three paths of target speech include: target mixed speech, target interference speech and preprocessed speech obtained after initial echo cancellation and/or noise cancellation are performed on the target mixed speech.

Exemplarily, as shown in FIG. 6B, the subband decomposition is performed on the target mixed speech, the target interference speech and the preprocessed speech to obtain the amplitude spectrums and the phase spectrums of the three paths of speech.

In S602, a prediction probability of the target mixed speech including target clean speech in a feature domain is determined according to the amplitude spectrums of the at least three paths of target speech.

Exemplarily, as shown in FIG. 6B, in the embodiment, the amplitude spectrums of the target mixed speech, the target interference speech and the preprocessed speech may all be input into a speech enhancement model including a convolutional neural network, a temporal convolutional network, a fully connected network and an activation network, so as to obtain the prediction probability of the target mixed speech including the target clean speech in the feature domain.

In S603, subband synthesis processing is performed according to the prediction probability and an amplitude spectrum and a phase spectrum of the preprocessed speech to obtain the target clean speech in the target mixed speech.

Optionally, an amplitude spectrum of the target clean speech is determined according to the prediction probability and the amplitude spectrum of the preprocessed speech, and the subband synthesis processing is performed on the amplitude spectrum of the target clean speech and the phase spectrum of the preprocessed speech to obtain the target clean speech.

Exemplarily, as shown in FIG. 6B, in the embodiment, the prediction probability output by the speech enhancement model may be multiplied by the amplitude spectrum of the preprocessed speech of the target speech, so as to obtain the amplitude spectrum of the target clean speech. Then, speech synthesis processing is performed on the amplitude spectrum of the target clean speech and the phase spectrum of the preprocessed speech based on the subband synthesis technology to obtain the target clean speech.

It can be seen from the comparison between FIG. 6C and FIG. 6D that knocks, that is, non-stationary short-time noises, in the target mixed speech can be well suppressed through the speech enhancement manner of the embodiment, and the problem can be solved that the conventional Wiener filter cannot suppress non-stationary short-time noises. It can be seen from the comparison between FIG. 6E and FIG. 6F that residual echoes, that is, nonlinear echoes, in the target mixed speech can be well suppressed through the speech enhancement manner of the embodiment, and the problem can be solved that the conventional normalized least mean squares filter cannot suppress nonlinear echoes.

According to the solution of the embodiment of the present disclosure, the subband decomposition is performed on the target mixed speech, the target interference speech of the target mixed speech and the preprocessed speech separately to determine the amplitude spectrums and the phase spectrums of the three paths of speech, the prediction probability of the target mixed speech including the target clean speech at each point in the feature domain is predicted based on the amplitude spectrums of the three paths of speech, and the target clean speech is obtained according to the prediction probability and the amplitude spectrum and the phase spectrum of the preprocessed speech and using the subband synthesis technology. In the process of performing speech enhancement on the mixed speech, the solution not only introduces the interference speech associated with the mixed speech, but also introduces the preprocessed speech of the mixed speech, so that only non-stationary short-time noises and/or nonlinear echoes need to be focused in the process of noise filtering and/or echo filtering; in this manner, the complexity of the speech enhancement process is reduced, facilitating the integration of echo and noise removal tasks into a system.

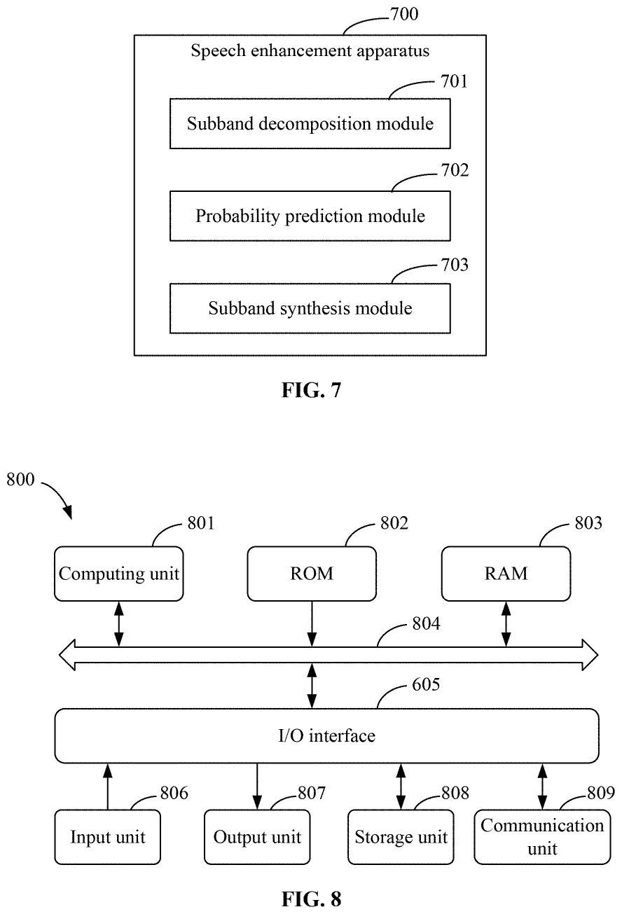

FIG. 7 is a structural diagram of a speech enhancement apparatus according to an embodiment of the present disclosure. The embodiment of the present disclosure is applicable to the case of performing speech enhancement on speech mixed with noises and/or echoes. The apparatus may be implemented by software and/or hardware, and the apparatus can implement the speech enhancement method according to any embodiment of the present disclosure. As shown in FIG. 7, the speech enhancement apparatus 700 includes a subband decomposition module 701, a probability prediction module 702 and a subband synthesis module 703.

The subband decomposition module 701 is configured to perform subband decomposition processing on at least two paths of target speech to obtain amplitude spectrums and phase spectrums of the at least two paths of target speech, where the at least two paths of target speech include: target mixed speech and target interference speech.

The probability prediction module 702 is configured to determine, according to the amplitude spectrums of the at least two paths of target speech, a prediction probability of the target mixed speech including target clean speech in a feature domain.

The subband synthesis module 703 is configured to perform, according to the prediction probability and the amplitude spectrums and the phase spectrums of the at least two paths of target speech, subband synthesis processing to obtain the target clean speech in the target mixed speech.

According to the solution of the embodiment of the present disclosure, the subband decomposition is performed on the target mixed speech and the target interference speech associated with the target mixed speech separately to determine the amplitude spectrums and the phase spectrums of the two paths of speech, the prediction probability of the target mixed speech including the target clean speech at each point in the feature domain is predicted based on the amplitude spectrums of the two paths of speech, and the target clean speech is extracted from the target mixed speech in combination with an amplitude spectrum and a phase spectrum of the target mixed speech and through the subband synthesis processing. According to the solution, the subband decomposition and subband synthesis technologies are used for replacing the related Fourier transform to execute the operations of speech frequency spectrum decomposition and speech frequency spectrum synthesis, and a longer analysis window is used, so that the correlation between various subbands is less, the subsequent task of noise filtering and/or echo filtering has a higher convergence efficiency, the noises and/or echoes in the target mixed speech can be cancelled to the maximum extent, and thus high-quality target clean speech can be obtained. In addition, in the speech enhancement process of the embodiment, the target interference speech associated with the noises and/or echoes in the target mixed speech is used, so that the quality of the target clean speech is further improved.

Further, the preceding subband decomposition module 701 includes a subband decomposition unit and a frequency spectrum determination unit.

The subband decomposition unit is configured to perform the subband decomposition processing on the at least two paths of target speech to obtain imaginary signals of the at least two paths of target speech.

The frequency spectrum determination unit is configured to determine, according to the imaginary signals of the at least two paths of target speech, the amplitude spectrums and the phase spectrums of the at least two paths of target speech.

Further, the apparatus further includes an amplitude spectrum updating module.

The amplitude spectrum updating module is configured to update, based on logarithm processing and/or normalization processing, the amplitude spectrums of the at least two paths of target speech.

Further, the preceding probability prediction module 702 is further configured to input the amplitude spectrums of the at least two paths of target speech into a speech enhancement model to obtain the prediction probability of the target mixed speech including the target clean speech in the feature domain, where the speech enhancement model includes: a convolutional neural network, a temporal convolutional network, a fully connected network and an activation network.

Further, the preceding speech enhancement model is obtained through supervised training based on a training sample, where the training sample includes: sample clean speech generated based on directivity of a microphone, sample interference speech, and sample mixed speech obtained by mixing different types of noises and/or echoes into the sample clean speech.

Further, the preceding subband synthesis module 703 is further configured to determine an amplitude spectrum of the target clean speech according to the prediction probability and an amplitude spectrum of the target mixed speech; and perform the subband synthesis processing on the amplitude spectrum of the target clean speech and a phase spectrum of the target mixed speech to obtain the target clean speech.

Further, the preceding at least two paths of target speech further include: preprocessed speech obtained after initial echo cancellation and/or noise cancellation are performed on the target mixed speech.

The preceding subband synthesis module 703 is further configured to perform, according to the prediction probability and an amplitude spectrum and a phase spectrum of the preprocessed speech, the subband synthesis processing to obtain the target clean speech in the target mixed speech.

The preceding product may perform the method provided in any embodiment of the present disclosure, and has functional modules for and beneficial effects of executing the method.

The acquisition, storage, application and the like of any piece of speech, such as mixed speech, interference speech and clean speech, involved in the technical solutions of the present disclosure are in compliance with relevant laws and regulations and do not violate public order and good customs.

According to an embodiment of the present disclosure, the present disclosure further provides an electronic device, a readable storage medium and a computer program product.

FIG. 8 is a block diagram of an example electronic device 800 that may be configured to implement an embodiment of the present disclosure. The electronic device is intended to represent various forms of digital computers, for example, a laptop computer, a desktop computer, a workbench, a personal digital assistant, a server, a blade server, a mainframe computer, or another applicable computer. Electronic devices may further represent various forms of mobile apparatuses, for example, personal digital assistants, cellphones, smartphones, wearable devices, and other similar computing apparatuses. Herein the shown components, the connections and relationships between these components, and the functions of these components are illustrative only and are not intended to limit the implementation of the present disclosure as described and/or claimed herein.

As shown in FIG. 8, the device 800 includes a computing unit 801. The computing unit 801 may perform various appropriate actions and processing according to a computer program stored in a read-only memory (ROM) 802 or a computer program loaded into a random-access memory (RAM) 803 from a storage unit 808. Various programs and data required for the operation of the device 800 may also be stored in the RAM 803. The computing unit 801, the ROM 802, and the RAM 803 are connected to each other through a bus 804. An input/output (I/O) interface 805 is also connected to the bus 804.

Multiple components in the device 800 are connected to the I/O interface 805. The multiple components include an input unit 806 such as a keyboard or a mouse, an output unit 807 such as various types of displays or speakers, the storage unit 808 such as a magnetic disk or an optical disc, and a communication unit 809 such as a network card, a modem or a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 801 executes various methods and processing described above, such as the speech enhancement method. For example, in some embodiments, the speech enhancement method may be implemented as computer software programs tangibly contained in a machine-readable medium such as the storage unit 808. In some embodiments, part or all of computer programs may be loaded and/or installed on the device 800 via the ROM 802 and/or the communication unit 809. When the computer program is loaded to the RAM 803 and executed by the computing unit 801, one or more steps of the preceding speech enhancement method may be executed. Alternatively, in other embodiments, the computing unit 801 may be configured, in any other suitable manner (for example, by means of firmware), to execute the speech enhancement method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of the present disclosure, the machine-readable medium may be a tangible medium that may include or store a program used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

Cloud computing refers to a technical system that accesses a shared elastic-and-scalable physical or virtual resource pool through a network, where resources may include servers, operating systems, networks, software, applications and storage devices and may be deployed and managed in an on-demand, self-service manner. Cloud computing can provide efficient and powerful data processing capabilities for artificial intelligence, the blockchain and other technical applications and model training.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modifications, equivalent substitutions, improvements, and the like made within the spirit and principle of the present disclosure fall within the scope of the present disclosure.

What is claimed is:

1. A speech enhancement method, comprising:
performing subband decomposition processing on at least two paths of target speech to obtain amplitude spectrums and phase spectrums of the at least two paths of target speech, wherein the at least two paths of target speech comprise: target mixed speech and target interference speech;
determining, according to the amplitude spectrums of the at least two paths of target speech, a prediction probability of the target mixed speech including target clean speech in a feature domain; and
performing, according to the prediction probability and the amplitude spectrums and the phase spectrums of the at least two paths of target speech, subband synthesis processing to obtain the target clean speech in the target mixed speech.

2. The method according to claim 1, wherein performing the subband decomposition processing on the at least two paths of target speech to obtain the amplitude spectrums and the phase spectrums of the at least two paths of target speech comprises:
performing the subband decomposition processing on the at least two paths of target speech to obtain imaginary signals of the at least two paths of target speech; and
determining, according to the imaginary signals of the at least two paths of target speech, the amplitude spectrums and the phase spectrums of the at least two paths of target speech.

3. The method according to claim 1, further comprising:
updating, based on at least one of logarithm processing or normalization processing, the amplitude spectrums of the at least two paths of target speech.

4. The method according to claim 2, further comprising:
updating, based on at least one of logarithm processing or normalization processing, the amplitude spectrums of the at least two paths of target speech.

5. The method according to claim 1, wherein determining, according to the amplitude spectrums of the at least two paths of target speech, the prediction probability of the target mixed speech including the target clean speech in the feature domain comprises:
inputting the amplitude spectrums of the at least two paths of target speech into a speech enhancement model to obtain the prediction probability of the target mixed speech including the target clean speech in the feature domain, wherein the speech enhancement model comprises: a convolutional neural network (CNN), a temporal convolutional network (TCN), a fully connected (FC) network and an activation network.

6. The method according to claim 5, wherein the speech enhancement model is obtained through supervised training based on a training sample, wherein the training sample comprises: sample clean speech generated based on directivity of a microphone, sample interference speech, and sample mixed speech obtained by mixing different types of at least one of noises or echoes into the sample clean speech.

7. The method according to claim 1, wherein performing, according to the prediction probability and the amplitude spectrums and the phase spectrums of the at least two paths of target speech, the subband synthesis processing to obtain the target clean speech in the target mixed speech comprises:
determining an amplitude spectrum of the target clean speech according to the prediction probability and an amplitude spectrum of the target mixed speech; and
performing the subband synthesis processing on the amplitude spectrum of the target clean speech and a phase spectrum of the target mixed speech to obtain the target clean speech.

8. The method according to claim 1, wherein the at least two paths of target speech further comprise: preprocessed speech obtained after at least one of initial echo cancellation or noise cancellation are performed on the target mixed speech; and
wherein performing, according to the prediction probability and the amplitude spectrums and the phase spectrums of the at least two paths of target speech, the subband synthesis processing to obtain the target clean speech in the target mixed speech comprises:
performing, according to the prediction probability and an amplitude spectrum and a phase spectrum of the preprocessed speech, the subband synthesis processing to obtain the target clean speech in the target mixed speech.

9. A speech enhancement apparatus, comprising: at least one processor and a memory communicatively connected to the at least one processor;
wherein the memory stores instructions executable by the at least one processor to cause the at least one processor to execute steps in the following modules:
a subband decomposition module configured to perform subband decomposition processing on at least two paths of target speech to obtain amplitude spectrums and phase spectrums of the at least two paths of target speech, wherein the at least two paths of target speech comprise: target mixed speech and target interference speech;
a probability prediction module configured to determine, according to the amplitude spectrums of the at least two paths of target speech, a prediction probability of the target mixed speech including target clean speech in a feature domain; and
a subband synthesis module configured to perform, according to the prediction probability and the amplitude spectrums and the phase spectrums of the at least two paths of target speech, subband synthesis processing to obtain the target clean speech in the target mixed speech.

10. The apparatus according to claim 9, wherein the subband decomposition module comprises:
a subband decomposition unit configured to perform the subband decomposition processing on the at least two paths of target speech to obtain imaginary signals of the at least two paths of target speech; and
a frequency spectrum determination unit configured to determine, according to the imaginary signals of the at least two paths of target speech, the amplitude spectrums and the phase spectrums of the at least two paths of target speech.

11. The apparatus according to claim 9, further comprising:
an amplitude spectrum updating module configured to update, based on at least one of logarithm processing or normalization processing, the amplitude spectrums of the at least two paths of target speech.

12. The apparatus according to claim 10, further comprising:
an amplitude spectrum updating module configured to update, based on at least one of logarithm processing or normalization processing, the amplitude spectrums of the at least two paths of target speech.

13. The apparatus according to claim 9, wherein the probability prediction module is further configured to:
input the amplitude spectrums of the at least two paths of target speech into a speech enhancement model to obtain the prediction probability of the target mixed speech including the target clean speech in the feature domain, wherein the speech enhancement model comprises: a convolutional neural network (CNN), a temporal convolutional network (TCN), a fully connected (FC) network and an activation network.

14. The apparatus according to claim 13, wherein the speech enhancement model is obtained through supervised training based on a training sample, wherein the training sample comprises: sample clean speech generated based on directivity, sample interference speech, and sample mixed speech obtained by mixing different types of at least one of noises or echoes into the sample clean speech.

15. The apparatus according to claim 9, wherein the subband synthesis module is further configured to:
determine an amplitude spectrum of the target clean speech according to the prediction probability and an amplitude spectrum of the target mixed speech; and
perform the subband synthesis processing on the amplitude spectrum of the target clean speech and a phase spectrum of the target mixed speech to obtain the target clean speech.

16. The apparatus according to claim 9, wherein the at least two paths of target speech further comprise: preprocessed speech obtained after at least one of initial echo cancellation or noise cancellation are performed on the target mixed speech; and
wherein the subband synthesis module is further configured to:
perform, according to the prediction probability and an amplitude spectrum and a phase spectrum of the preprocessed speech, the subband synthesis processing to obtain the target clean speech in the target mixed speech.

17. A non-transitory computer-readable storage medium storing computer instructions for causing a computer to execute the following steps:
performing subband decomposition processing on at least two paths of target speech to obtain amplitude spectrums and phase spectrums of the at least two paths of target speech, wherein the at least two paths of target speech comprise: target mixed speech and target interference speech;
determining, according to the amplitude spectrums of the at least two paths of target speech, a prediction probability of the target mixed speech including target clean speech in a feature domain; and
performing, according to the prediction probability and the amplitude spectrums and the phase spectrums of the at least two paths of target speech, subband synthesis processing to obtain the target clean speech in the target mixed speech.

18. The storage medium according to claim 17, wherein performing the subband decomposition processing on the at least two paths of target speech to obtain the amplitude spectrums and the phase spectrums of the at least two paths of target speech comprises:
performing the subband decomposition processing on the at least two paths of target speech to obtain imaginary signals of the at least two paths of target speech; and
determining, according to the imaginary signals of the at least two paths of target speech, the amplitude spectrums and the phase spectrums of the at least two paths of target speech.

19. The storage medium according to claim 17, further comprising:
updating, based on at least one of logarithm processing or normalization processing, the amplitude spectrums of the at least two paths of target speech.

20. The storage medium according to claim 17, wherein determining, according to the amplitude spectrums of the at least two paths of target speech, the prediction probability of the target mixed speech including the target clean speech in the feature domain comprises:
inputting the amplitude spectrums of the at least two paths of target speech into a speech enhancement model to obtain the prediction probability of the target mixed speech including the target clean speech in the feature domain, wherein the speech enhancement model comprises: a convolutional neural network (CNN), a temporal convolutional network (TCN), a fully connected (FC) network and an activation network.
